(19) United States
(12) Patent Application Publication
(10) Pub. No.: US 2009/0242064 A1
(43) Pub. Date: Oct. 1, 2009

(54) HOSE

(76) Inventor: Tat Wing Lai, Hong Kong (CN)

Correspondence Address: HAMRE, SCHUMANN, MUELLER & LARSON, P.C., P.O. BOX 2902, MINNEAPOLIS, MN, 55402-0902, US

(21) Appl. No.: 12/411,034

(22) Filed: Mar. 25, 2009

(30) Foreign Application Priority Data
Mar. 26, 2008 (CN) 200820093023.1

(51) Int. Cl. F16L 11/00; B61G 5/00

(52) U.S. Cl. 138/117; 285/25; 138/116

(57) ABSTRACT

The present invention provides a hose. The hose comprises a through hole therethrough and defines at least one recess and at least one convex portion on an outer surface thereof. The at least one recess matches with the at least one convex portion in shape. The hose of the present invention is used to sheath a surface of an object so that the object can be orderly arranged through interconnection of the at least one recess and the at least one convex portion on the outer surface of the hose.

### TECHNICAL FIELD

The present invention relates to a hose.

### BACKGROUND

In daily life, after listening to music, one may put the MP3 with ear-plug and conductive wire into the bag. In this way, the ear plug with the conductive wire is generally put away in disorder. It is inconvenient to take other things out of the bag in the risk of being caught up by the conductive wire. It is the same case with conductive wire based mobile charger. After using a mobile charger with the conductive wire, one will put it in away order, for example, by binding the folded wire with a line. However, such binding means is neither convenient nor attractive. Another similar case is flower arrangement, which is formed by a bunch of plastic flowers with a copper wire as its root for each flower. A plurality of plastic flowers with copper wires is bound together using a line, accordingly forming the bunch of plastic flowers. However, it is also extremely inconvenient to arrange orderly and attractively the bunch of plastic flowers bound with a number of copper wires.

### SUMMARY

An object of the present invention is to provide a hose, which can orderly arrange an object.

In order to achieve the above object, an embodiment of the present invention provides a hose. The hose comprises a through hole therethrough and defines at least one recess and at least one convex portion on an outer surface. The at least one recess matches with the at least one convex portion in shape.

Preferably, the at least one recess and the at least one convex portion are arranged along an axis of the hose.

Alternatively, the at least one recess and the at least one convex portion are arranged horizontally along the hose.

Preferably, the at least one recess on the outer surface of the hose is disposed opposite to the at least one convex portion.

More preferably, the opposite at least one recess and at least one convex portion in a vis-à-vis position are disposed axially and alternately on the outer surface of the hose.

Preferably, the through hole is round, rectangular or irregular in shape.

More preferably, the at least one recess and the at least one convex portion are both round. The at least one recess is in an oval shape and the at least one convex portion is in a barbed shape.

Further, the matching at least one recess and at least one convex portion comprises at least a pair of recess and convex portion. Preferably, the at least a pair of recess and convex portion comprises a plurality of pairs of recesses and convex portions. The plurality of pairs of recesses and convex portions are arranged uniformly on the surface of the hose. Each recess and each convex portion respectively extend along the axis of the hose.

Preferably, the hose is made from a rubber material.

In the above embodiment of the present invention, the hose is used to sheath a surface of an object to be orderly arranged through interconnection of the at least one recess and the at least one convex portion on the outer surface of the hose. For example, soft bar-shaped objects sheathed in the hole of the hose can be rolled and orderly arranged with help of the at least one recess and the at least one convex portion on the outer surface of the hose. Alternatively, one can force the at least one recess to engage with the at least one convex portion of the hoses sheathed on many bar-shaped objects to orderly arrange the separate objects.

### DRAWINGS

FIG. 1 is a perspective view of a hose in accordance with an embodiment of the present invention.

FIG. 2 is a perspective view showing engagement of the two hoses of FIG. 1.

FIG. 3 is a perspective view of another hose in accordance with another embodiment of the present invention.

### DETAILED DESCRIPTION

Objects, advantages and embodiments of the present invention will be explained below in detail with reference to the accompanying drawings. However, it is to be appreciated that the following description of the embodiment(s) is merely exemplary in nature and is no way intended to limit the invention, its application, or uses.

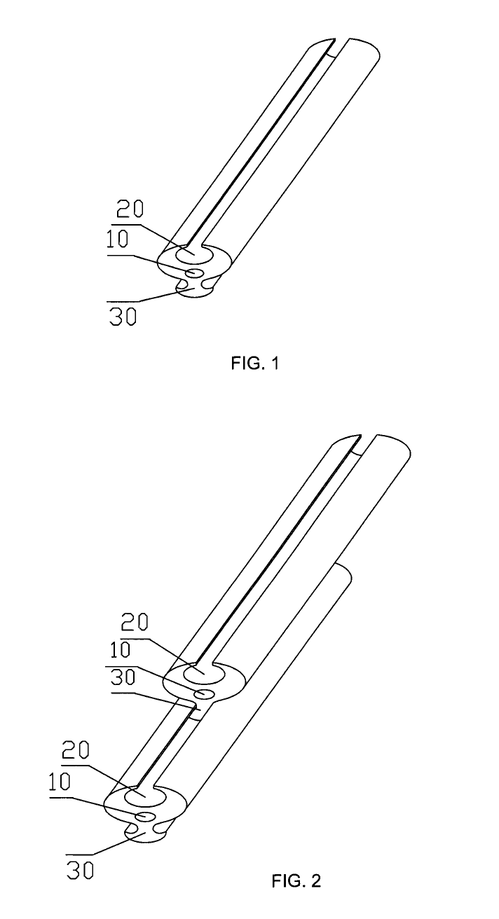

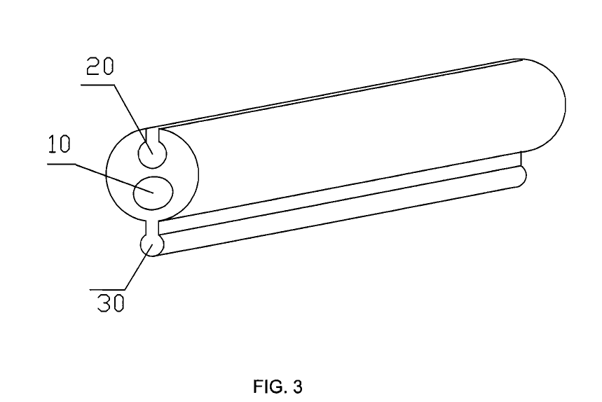

With reference to FIG. 1 to FIG. 3, a hose is illustrated in accordance with one embodiment of the present invention. The hose has a through hole 10 therein and defines at least one recess 20 and at least one convex portion 30 on an outer surface thereof. The at least one recess 20 matches with the at least one convex portion 30 in shape, respectively. The at least one recess 20 and the at least one convex portion 30 can be mutually matched and securely fixed to each other. The hose is used to sheath a surface of the object so that the object can be orderly arranged through interconnection of the at least one recess 20 and the at least one convex portion 30 on the outer surface of the hose.

In this embodiment, the at least one recess 20 and the at least one convex portion 30 are both arranged along an axis of the hose, alternatively, are arranged horizontally along the hose. In the case of axially arranged recess 20 and convex portion 30, the recess 20 is disposed opposite to the convex portion 30 on the outer surface of the hose. In another embodiment, the at least one recess 20 and the at least one convex portion 30 in a vis-à-vis position are disposed axially and alternatively on the outer surface of the hose. Each recess 20 and each convex portion 30 extend along the axis of the hose. In the illustrated embodiment, for example, the hose defines a recess 20 and a convex portion 30 extending along the axis thereof in a vis-à-vis position. If the adjacent recess 20 and convex portion 30 are alternately and uniformly arranged around the partial surface of the hose in such an order of from initial recess to next convex portion at one side of the hose, the adjacent recess 20 and convex portion 30 at the other side of the hose are alternately and uniformly arranged around the remainder partial surface of the hose at this side in such an order of from initial convex portion to next recess accordingly. The recess 20 is oval formed by inward concaved outer surface of the hose, while the convex portion 30 is barbed-shaped formed by upward convex outer surface of the hose in a vis-à-vis position with respect to one respective recess 20. The recess 20 and the convex portion 30 match well in their shapes and can be engaged and fixed with each other securely. In another embodiment, the shapes of the recess 20 and the convex portion 30 are respectively as follow: the recess 20 is round formed by inward concaved outer surface of the hose and the convex portion 30 is round formed by upward convex outer surface of the hose in a vis-à-vis position. The recess 20 and the convex portion 30 match well in their shapes and can be engage and fixed with each other securely. However, it should be understood that it is feasible that the recess 20 and the convex portion 30 are formed with other means, if only they can be engage and fixed with each other securely. Variations of this embodiment, for example alternations and modifications to the recess and the convex portion, are not illustrated herein, but should be contemplated as within the scope of the present invention.

Nevertheless, it is to be understood that one or more pair of recesses and convex portions could be applied on the outer surface of the hose according to requirement. The hose is made of a rubber material. Softness of the hose and size of the through hole can be selected according to requirement. The through hole of the hose is in various shapes, such as round, rectangular or irregular, etc.

The operation of above embodiments can be described in following examples.

Taking an example of an ear-plug with a conductive wire, the hose in above embodiment can be sheathed on the surface of the conductive wire, for example along an axis of the wire, alternatively, the conductive wire is coated with the hose with the at least one recess 20 and the at least one convex portion 30 through an injection molding method. After listening to MP3, one can roll up the conductive wire by tightly engaging the recess with the respective convex portion of the hose sheathing on the wire, thereby arranging orderly the conductive wire. The mobile charger with a conductive wire is also arranged orderly using the same method.

Another similar case is flower arrangement. Every flower needs a copper line as its root. The surface of the copper line can be sheathed in the hole of the present hose of the embodiment. Then, many separate copper lines can be engaged together to form a bunch of beautiful plastic flowers through mutual interconnection and close fixation of the recess 20 and the respective convex portion 30 on the outer surface of every hose.

It can be realized that the hose according to the embodiment of the present invention is used to sheath the surface of an object to be orderly arranged through interconnection of the recess 20 and the respective convex portion 30 on the outer surface of the hose. For example, soft bar-shaped objects sheathed in the hole of the hose can be rolled and orderly arranged with help of the recess 20 and the convex portion 30 on the outer surface of the hose, alternatively, one can force the recess 20 to engage with the respective convex portion 30 of the hoses sheathed on many bar-shaped objects to orderly arrange the dispersed objects.

The described embodiments are to be considered in all respects only as illustrative and not restrictive. The scope of the invention is therefore, indicated by the appended claims rather than by the foregoing description. All modifications, equivalences, and alternations which come within the spirit and principle of the present invention are to be embraced within their scope of the present invention.

1. A hose, comprising:
a through hole therethrough, the hose defining at least one recess and at least one convex portion on an outer surface of the hose, each recess matching with one respective convex portion in shape.

2. The hose of claim 1, wherein the at least one recess and the at least one convex portion are arranged along an axis of the hose.

3. The hose of claim 1, wherein the at least one recess and the at least one convex portion are arranged horizontally along the hose.

4. The hose of claim 2, wherein the at least one recess on the outer surface of the hose is disposed opposite to the at least one convex portion.

5. The hose of claim 4, wherein the opposite at least one recess and at least one convex portion in a vis-à-vis position are disposed axially and alternately on the outer surface of the hose.

6. The hose of claim 1, wherein the through hole is round, rectangular or irregular in shape.

7. The hose of claim 1, wherein the at least one recess and the at least one convex portion are both round.

8. The hose of claim 1, wherein the at least one recess is in an oval shape and the convex portion is in a barbed shape.

9. The hose of claim 1, wherein the matching at least one recess and at least one convex portion comprises at least a pair of recess and convex portion.

10. The hose of claim 1, wherein the hose is made from a rubber material.

11. The hose of claim 1, wherein the at least a pair of recess and convex portion comprises a plurality of pairs of recesses and convex portions.

12. The hose of claim 1, wherein each recess and each convex portion respectively extend along an axis of the hose.
